(19) United States
(12) Patent Application Publication
(10) Pub. No.: US 2017/0123783 A1
(43) Pub. Date: May 4, 2017

(54) Method for displaying plug-in view elements in host application page and electronic device

(71) Applicants: Le Holdings (Beijing) Co., Ltd., Beijing (CN); LE SHI INTERNET INFORMATION&TECHNOLOGY CORP., BEIJING, BEIJING (CN)

(72) Inventors: Liwei LIU, Beijing (CN); Ruotao WANG, Beijing (CN)

(21) Appl. No.: 15/242,461

(22) Filed: Aug. 19, 2016

Related U.S. Application Data
(63) Continuation of application No. PCT/CN2016/083051, filed on May 23, 2016.

(30) Foreign Application Priority Data
Oct. 28, 2015 (CN) 201510712954X

(51) Int. Cl. G06F 9/445; G06F 9/50

(52) U.S. Cl. CPC G06F 8/65; G06F 9/5027

(57) ABSTRACT

Disclosed is a method for displaying plug-in view elements in host application page and electronic device. The method includes: loading a plug-in when the host application is started; acquiring the plug-in view elements constructed by the plug-in and a context capable of being called by the plug-in view elements; and adding and displaying the plug-in view elements into the host application page, according to the context.

### CROSS REFERENCE TO RELATED APPLICATIONS

This application is based upon and claims priority to Chinese Patent Application NO. 201510712954.X, titled “Method and apparatus for displaying plug-in view elements in host application page”, filed Oct. 28, 2015, the entire contents of which are incorporated herein by reference.

### TECHNICAL FIELD

The disclosure relates to the technical field of intelligent terminal applications, and in particular to a method and apparatus for displaying plug-in view elements in a host application page.

### BACKGROUND

With the popularity of smart phones or smart tablet in recent years, the usage of android phones increases rapidly, and the total number of applications installed on each of the users' phones on average also significantly increases. Data show that each of the users' android phones may install 95 applications on average, and the number of the frequently used applications is up to 35.

Due to the user's enthusiasm, a new version is released every week for the majority of applications for users, to provide the users with the latest function or the most stable experience. However, problem comes out. Too many applications need to be updated, an ordinary user of android phone may receive reminders of updating different applications every day, and the processes of confirming update, downloading an update package and installing the update package are performed to update an application. For a general installation package of 15M capacity for an application, 2 to 3 minutes may be wasted in updating each application for the users, and endless updating a large number of applications cause users to generate a sense of weariness on the applications. Therefore, a plug-in application which requires no installation for users emerges, with which the function of the application may be updated and errors in the application may be repaired under a completely silent circumstance, thereby improves the user's experience. The user's normal use is not interfered, no additional energy and time is taken or spent for the users, and the applications can be the latest version at any time.

The process of dividing an application into two parts, i.e., a host and plug-in, based on the inherent logic is referred to as a plug-in. Since an android application must be installed before its running, the host refers to the normally installed part. Then the host reads and displays plug-in content which can be updated independently outside, that is, the function of updating the application without disrupting the user can be achieved.

However, the same problem exists in all current solutions for the plug-in, that is, the plug-in part is opened by the host only in the form of a page, which causes that the host and the plug-in are completely separated in the inherent logic. FIG. 7 shows an implementation way of a plug-in solution in the conventional technology. As shown in FIG. 7, the host management and the plug-in management both are a whole page (i.e., Activity, which is an alternative name of a page in the android application), there is no effective way of interaction between the both, with a large limitation, thus, the plug-in cannot be streamed into a smaller unit with the host application together. That is, the plug-in elements cannot be displayed in a part of the host page through the existing plug-in solution.

### SUMMARY

In view of aforesaid problems, the disclosure is put forward to provide a method and apparatus for displaying plug-in view elements in a host application page, so as to display the plug-in view elements in at least a part of the host application page, thereby optimizing the plug-in solution.

According to one aspect of the disclosure, a method for displaying plug-in view elements in a host application page is provided, which includes:

loading a plug-in when the host application is started;

acquiring the plug-in view elements constructed by the plug-in and a context being capable of called by the plug-in view elements; and

adding and displaying the plug-in view elements into the host application page, according to the context.

According to another aspect of the disclosure, an apparatus for displaying plug-in view elements in a host application page is provided, which includes:

a loading module, configured to load a plug-in when the host application is started;

an acquiring module, configured to acquire the plug-in view elements constructed by the plug-in and a context capable of being called by the plug-in view elements; and

a displaying module, configured to add and display the plug-in view elements into the host application page, according to the context.

With the method and apparatus according to the disclosure, the context which can be called by the plug-in view elements is acquired, and the plug-in view elements are added and displayed into the host application page according to the context, in the loading process of the host application page. With the solution, the plug-in view elements may be loaded and displayed in any part of any page of the host application, interface styles and internal logic can be updated silently at any time without requiring users to reinstall the application.

Above description is only a summary of the technical scheme of the disclosure. In order to know the technical means of the disclosure more clearly so that it can be put into effect according to the content of the description, and to make aforesaid and other purpose, features and advantages of the disclosure clearer, embodiments of the disclosure are listed below.

### BRIEF DESCRIPTION OF THE DRAWINGS

By reading the detailed description of the preferably selected embodiments below, various other advantages and benefits become clear for a person of ordinary skill in the art. The drawings are only used for showing the purpose of the preferred embodiments and are not intended to limit the display invention. And in the whole drawings, same drawing reference signs are used for redisplaying same components. In the drawings:

FIG. 1 shows a flowchart of a method for displaying plug-in view elements in a host application page according to some embodiments of the disclosure;

FIG. 2a shows a flowchart of a method for displaying plug-in view elements in a host application page according to some embodiments of the disclosure;

FIG. 2b shows a schematic flow interaction diagram of a method for displaying plug-in view elements in a host application page according to some embodiments of the disclosure;

FIG. 2c shows an implementation way of a plug-in solution according to the disclosure;

FIG. 3 shows a flowchart of a method for displaying plug-in view elements in a host application page according to some embodiments of the disclosure;

FIG. 4 shows a functional block diagram of an apparatus for displaying plug-in view elements in a host application page according to some embodiments of the disclosure;

FIG. 5 shows a functional block diagram of an apparatus for displaying plug-in view elements in a host application page according to some embodiments of the disclosure;

FIG. 6 shows a functional block diagram of an apparatus for displaying plug-in view elements in a host application page according to some embodiments of the disclosure;

FIG. 7 shows an implementation way of a plug-in solution in the conventional technology;

FIG. 8 schematically shows a block diagram of a computing device for executing the method for displaying plug-in view elements in a host application page according to some embodiments of the disclosure; and

FIG. 9 schematically shows a storage cell for holding or carrying procedure codes for realizing the method for displaying plug-in view elements in a host application page according to some embodiments of the disclosure.

### DETAILED DESCRIPTION

The disclosure is described in further detail with reference to the drawings and embodiments below. Although the drawings show exemplary embodiments of the disclosure, it should be understood that the disclosure may be implemented in various forms but should not be limit to the embodiments set forth herein. On the contrary, these embodiments are contributed to a more thorough understanding of the disclosure, and can completely convey the scope of the disclosure to those skilled in the art.

Through a more in-depth study based on the original plug-in framework, the more fine-grained plug-in inside the android application is achieved according to the disclosure, and thus the smallest component in the android application may be plug-in independently, thereby significantly increasing the flexibility of the plug-in. Specifically, after a host application is started and a plug-in is loaded, plug-in view elements constructed by the plug-in and a context being capable of called by the plug-in view elements are acquired, and the plug-in view elements are added and displayed into the host application page according to the context. With the solution, the plug-in view elements may be loaded and displayed in any part of any page of the host application, interface styles and internal logic can be updated silently at any time without requiring users to reinstall the application.

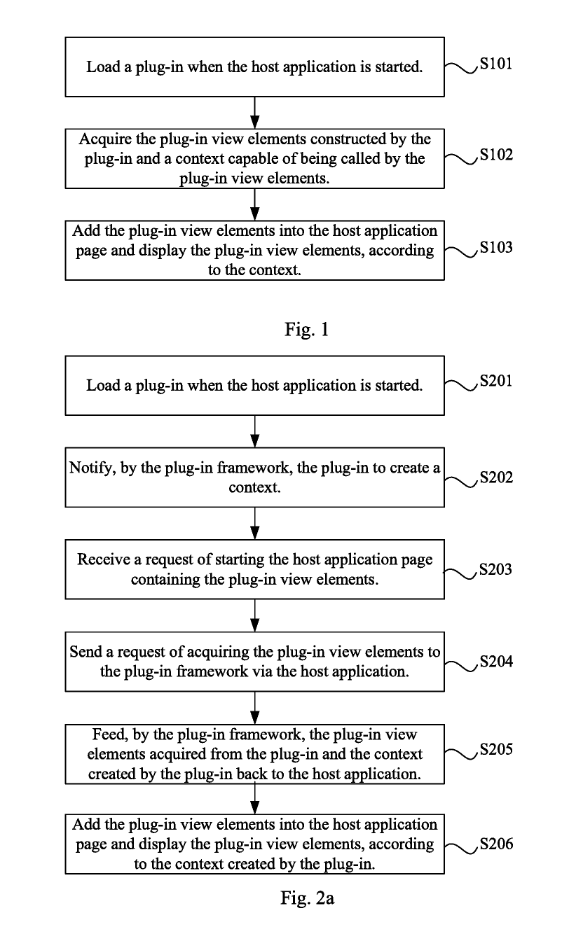

FIG. 1 shows a flowchart of a method for displaying plug-in view elements in a host application page according to a first embodiment of the disclosure. As shown in FIG. 1, the method includes the following steps S101 to S103.

In step S101, a plug-in is loaded when the host application is started.

A plug-in is an installation package file for an application, which is read by the host application via a plug-in framework to display its content. After the plug-in file is updated, the updating can be implemented by the host application rereading the updated plug-in file. The plug-in framework may be integrated into the host application, such that the host application has a function of reading and displaying the plug-in content.

In the embodiment of the disclosure, the process of loading a plug-in in the host application includes: initializing a plug-in framework when the host application is started; reading a plug-in file via the plug-in framework; and loading the plug-in file into memory of the host application.

In step S102, the plug-in view elements constructed by the plug-in and a context capable of being called by the plug-in view elements are acquired.

In the embodiment of the disclosure, the plug-in view elements may contain one or more view base units and/or a view unit capable of being added independently into the host application page and composed of one or more view base units. Specifically, the view base units are base units for displaying words, shapes, images, or videos on the screen in the android application, indicated by ‘view’. Generally, a whole page is composed of one or more views. The view unit capable of being added independently into the host application page is a constituent part of the page in the android application, indicated by ‘fragment’, which is composed of one or more views.

The logic of the plug-in part inherits the original view class or fragment class of the android application. In the disclosure, the context (indicated by ‘context’) capable of being called is acquired for the plug-in view elements in a creative or modificative way, so that the plug-in view elements can be added by the host application using the additional acquired context object when loading the page. In the actual implementation, a layer of packaging is prepared for the plug-in framework in advance, to open interfaces for initializing the plug-in framework and acquiring the view object and the fragment object in the plug-in. The packaged plug-in framework is packed into a code base, which is integrated into the host application together with the plug-in file. Finally, the host application acquires the view object or the fragment object in the plug-in through the open interfaces of the plug-in framework.

Optionally, the context contains resource file management and processing logic for class loading.

In step S103, the plug-in view elements are added and displayed into the host application page, according to the context.

After the context capable of being called by the plug-in view elements are acquired, the plug-in view elements constructed by the plug-in may be added into the host application page as other view elements in the host application page. The difference from other view elements in the host application page is that different context is called by the plug-in view elements.

With the method according to the embodiment, the context which can be called by the plug-in view elements is acquired, and the plug-in view elements are added and displayed into the host application page according to the context, in the loading process of the host application page. With the solution, the plug-in view elements may be loaded and displayed in any part of any page of the host application, interface styles and internal logic can be updated silently at any time without requiring users to reinstall the application. In a typical application scene, an advertiser may self-develop an adware with the method according to the disclosure, and provide the adware to the application integration which needs to display advertising. The adware may be displayed in any part of the application, the updating and upgrading of this part is controlled by the advertiser's own, and the users don't need to manually install a new version of application package to update the application. The advertiser only occupies a small portion of the page to display advertising, but a newly started page is a page contained in the plug-in with the existing other plug-in technology, which is not adapted to the scene appearing at a very high rate in android application.

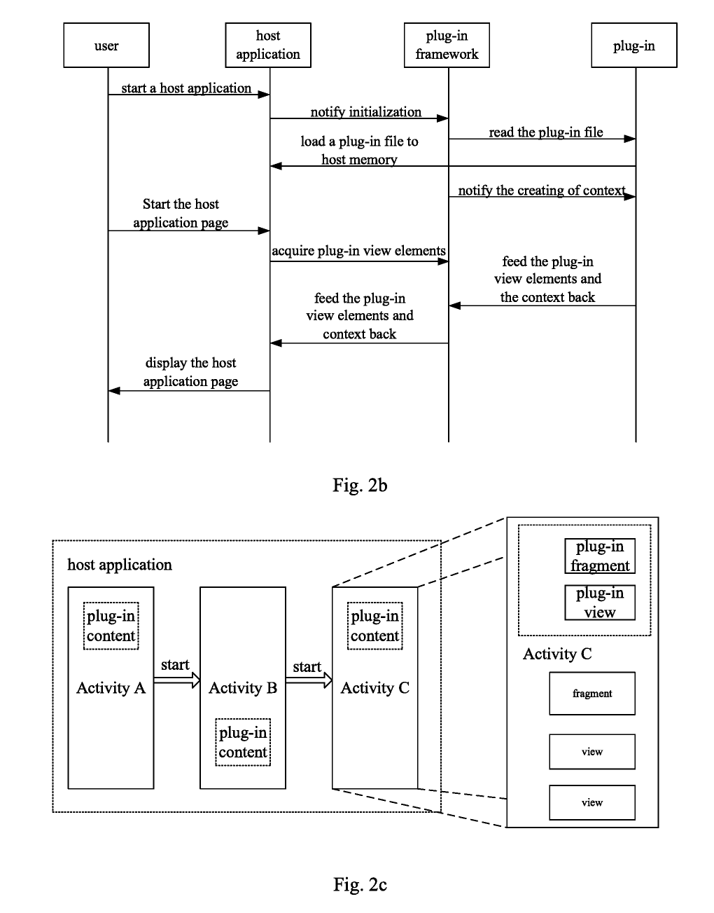

FIG. 2a shows a flowchart of a method for displaying plug-in view elements in a host application page according to some embodiments of the disclosure, and FIG. 2b shows a schematic flow interaction diagram of a method for displaying plug-in view elements in a host application page according to some embodiments of the disclosure. Some embodiments is described in detail in conjunction with FIG. 2a and FIG. 2b hereinafter. As shown in FIG. 2a, the method includes the following steps S201 to S206.

In step S201, a plug-in is loaded when the host application is started.

Referring to FIG. 2b, the process of loading a plug-in in the host application includes: firstly, triggering and starting the host application by the user, notifying by the host application a plug-in framework to be initialized; reading a plug-in file via the plug-in framework; and loading the plug-in file into memory of the host application.

In step S202, the plug-in is notified by the plug-in framework to create a context.

In the embodiment, the context object capable of being called by the view elements in the plug-in is obtained in a creation way. Specifically, after the plug-in is loaded by the host application, the plug-in framework notifies the plug-in that the context object is created with a view object or a fragment object in the plug-in. The context object contains resource file management and processing logic for class loading, and the view object or the fragment object is loaded and displayed by calling the processing logic.

In step S203, a request of starting the host application page containing the plug-in view elements is received.

Referring to FIG. 2b, the user triggers and starts the host application page containing the plug-in view elements.

In step S204, a request of acquiring the plug-in view elements is sent by the host application to the plug-in framework.

In step S205, the plug-in view elements acquired from the plug-in and the context created by the plug-in are fed back by the plug-in framework to the host application.

In the actual implementation, a layer of packaging is prepared for the plug-in framework in advance, to open interfaces for initializing the plug-in framework and acquiring the view object and the fragment object in the plug-in. The packaged plug-in framework is packed into a code base, which is integrated into the host application together with the plug-in file. In the step, the host application acquires the view object or the fragment object in the plug-in through the open interfaces of the plug-in framework.

On the premise that the plug-in is notified by the plug-in framework to create the context object in step S202, the host application acquires the view object or the fragment object and acquires the context object which can be called through the open interfaces of the plug-in framework in step S205.

In step S206, the plug-in view elements are added and displayed into the host application page, according to the context created by the plug-in.

After the context created by the plug-in is acquired, the plug-in view elements call the created context and are added into the host application page. That is, the view object or the fragment object constructed by the plug-in are loaded and displayed into the host application page by calling processing logic included in the context object created by the plug-in.

FIG. 2c shows an implementation way of a plug-in solution according to the disclosure. As shown in FIG. 2c, the plug-in content may be loaded and displayed in a host application management page. That is, not only the view object or the fragment object managed by the host application itself, but also the view object or the fragment object managed by the plug-in are contained in the host application page. Therefore, the more fine-grained plug-in inside the android application is achieved, and thus the smallest component in the android application may be plug-in independently, thereby significantly increasing the flexibility of the plug-in.

In the method according to the above embodiments, the context capable of being called by the plug-in view elements is created by the plug-in itself, the plug-in view elements are fed by the plug-in while the context is fed to the host application, so that the host application loads and displays the plug-in view elements into the page using the context. With the solution, the plug-in may update silently the plug-in content to update silently interface styles and inherent logic of the host application page.

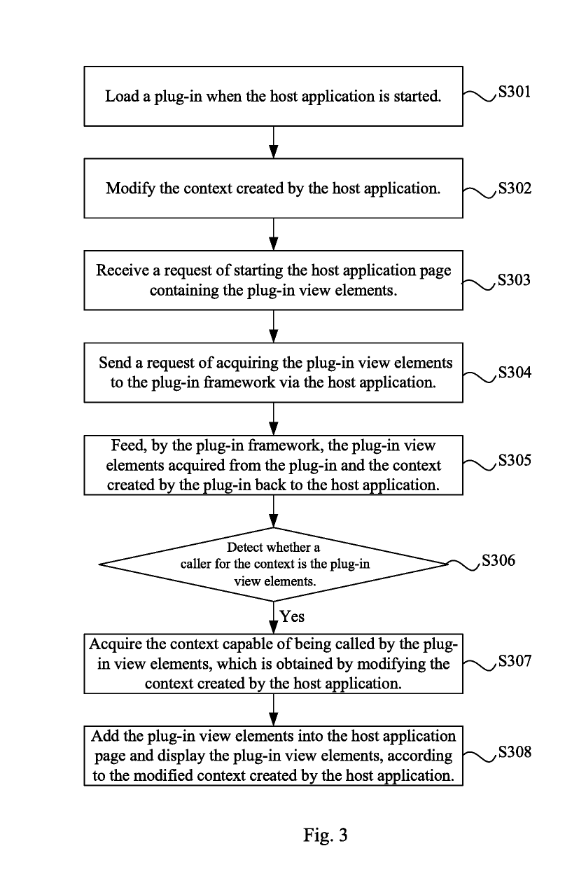

FIG. 3 shows a flowchart of a method for displaying plug-in view elements in a host application page according to some embodiments of the disclosure. As shown in FIG. 3, the method includes the following steps S301 to S308.

In step S301, a plug-in is loaded when the host application is started.

The process of loading a plug-in in the host application includes: firstly, triggering and starting the host application by the user, notifying by the host application a plug-in framework to be initialized; reading a plug-in file via the plug-in framework; and loading the plug-in file into memory of the host application.

In step S302, the context created by the host application is modified.

In the embodiment, the context object capable of being called by the view elements in the plug-in is obtained in a modification way. Specifically, after the plug-in is loaded by the host application, for the context object used by the plug-in view elements, resource file management and processing logic for class loading in the context object created by the host application may be rewritten, so that the context object can be called by the plug-in view elements. The modified or rewritten context object is compatible with processing logic of the plug-in view elements and processing logic of the host view elements.

In step S303, a request of starting the host application page containing the plug-in view elements is received.

In step S304, a request of acquiring the plug-in view elements is sent by the host application to the plug-in framework.

In step S305, the plug-in view elements acquired from the plug-in and the context created by the plug-in are fed back by the plug-in framework to the host application.

In the actual implementation, a layer of packaging is prepared for the plug-in framework in advance, to open interfaces for initializing the plug-in framework and acquiring the view object and the fragment object in the plug-in. The packaged plug-in framework is packed into a code base, which is integrated into the host application together with the plug-in file. In the step, the host application acquires the view object or the fragment object in the plug-in through the open interfaces of the plug-in framework.

In step S306, it is detected whether a caller for the context is the plug-in view elements. If the caller for the context is the plug-in view elements, step S307 is performed.

Step S306 is performed in the process of loading and displaying the host application page. Since not only the view elements managed by the host application itself (host view elements), but also the view elements managed by the plug-in (plug-in view elements) are contained in the host application page, it is detected dynamically that the caller for the context object is whether the plug-in view elements or the host view elements in the loading. If the caller for the context object is the plug-in view elements, step S307 is performed; if the caller for the context object is the host view elements, the host view elements are loaded and displayed according to the normal processing logic of the host view elements.

In step S307, the context capable of being called by the plug-in view elements, which is obtained by modifying the context created by the host application, is acquired. That is, the context object modified or rewritten in step S302 is acquired.

In step S308, the plug-in view elements are added and displayed into the host application page, according to the modified context created by the host application.

After the modified context created by the host application is acquired, the plug-in view elements call the modified context and are added into the host application page. That is, the view object or the fragment object constructed by the plug-in are loaded and displayed into the host application page by calling processing logic included in the modified context object created by the host application.

In the method according to the above embodiments, the host application modifies the context created by own such that the modified context is compatible with the processing logic of the plug-in view elements. After the plug-in view elements are fed by the plug-in, the host application loads and displays the plug-in view elements into the page using the modified context. With the solution, the plug-in may update silently plug-in content to update silently interface styles and inherent logic of the host application page.

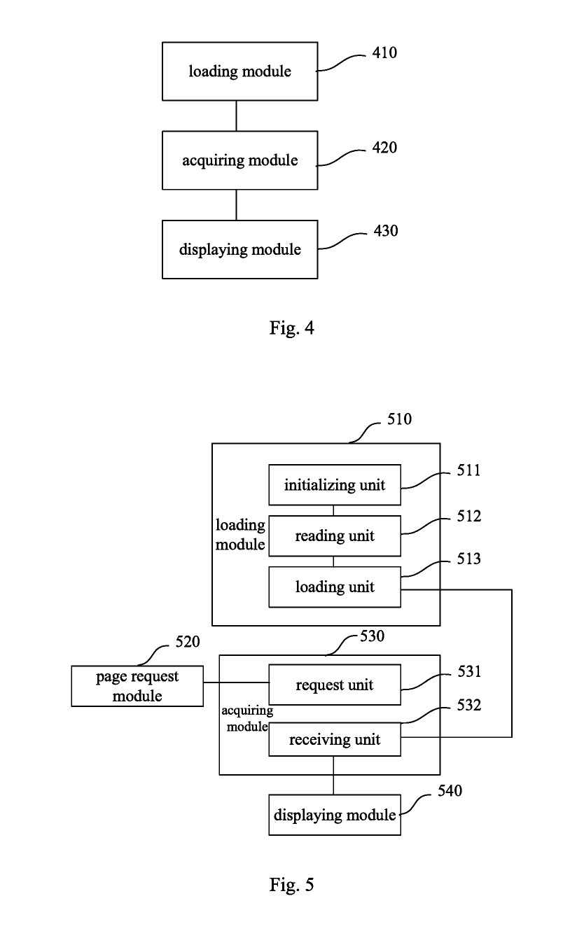

FIG. 4 shows a functional block diagram of an apparatus for displaying plug-in view elements in a host application page according to some embodiments of the disclosure. As shown in FIG. 4, the apparatus includes: a loading module 410, an acquiring module 420, and a displaying module 430.

The loading module 410 is configured to load a plug-in when the host application is started.

The acquiring module 420 is configured to acquire the plug-in view elements constructed by the plug-in and a context capable of being called by the plug-in view elements.

Here, the plug-in view elements may contain one or more view base units and/or a view unit capable of being added independently into the host application page and composed of one or more view base units.

The logic of the plug-in part inherits the original view class or fragment class of the android application. In the disclosure, the context capable of being called is acquired for the plug-in view elements in a creation or modification way, so that the plug-in view elements can be added by the host application using the additional acquired context object when loading the page. In the actual implementation, a layer of packaging is prepared for the plug-in framework in advance, to open interfaces for initializing the plug-in framework and acquiring the view object and the fragment object in the plug-in. The packaged plug-in framework is packed into a code base, which is integrated into the host application together with the plug-in file. Here, the acquiring module 420 acquires the view object or the fragment object in the plug-in through the open interfaces of the plug-in framework.

The acquiring module 420 is specifically configured to acquire the plug-in view elements constructed by the plug-in and a context capable of being called by the plug-in view elements, the context containing resource file management and processing logic for class loading.

The displaying module 430 is configured to add and display the plug-in view elements into the host application page, according to the context.

In the apparatus according to the embodiment, the context which can be called by the plug-in view elements is acquired, and the plug-in view elements are added and displayed into the host application page according to the context, in the loading process of the host application page. With the apparatus, the plug-in view elements may be loaded and displayed in any part of any page of the host application, interface styles and internal logic can be updated silently at any time without requiring users to reinstall the application.

FIG. 5 shows a functional block diagram of an apparatus for displaying plug-in view elements in a host application page according to some embodiments of the disclosure. As shown in FIG. 5, the apparatus includes: a loading module 510, a page request module 520, an acquiring module 530, and a displaying module 540. The loading module 510 further includes: an initializing unit 511, a reading unit 512, and a loading unit 513; and the acquiring module 530 further includes: a request unit 531 and a receiving unit 532.

The loading module 510 is configured to load a plug-in when the host application is started. Specifically, the initializing unit 511 is configured to initialize a plug-in framework when the host application is started; the reading unit 512 is configured to read a plug-in file via the plug-in framework; and the loading unit 513 is configured to load the plug-in file into memory of the host application.

The acquiring module 530 is configured to acquire a context created by the plug-in. Specifically, the request unit 531 is configured to send a request of acquiring the plug-in view elements to the plug-in framework via the host application; and the receiving unit 532 is configured to receive the plug-in view elements acquired by the plug-in framework from the plug-in and the context created by the plug-in.

In the embodiment, the context object capable of being called by the view elements in the plug-in is created by the plug-in. Specifically, after the plug-in is loaded by the host application, the plug-in framework notifies the plug-in that the context object is created with a view object or a fragment object in the plug-in. The context object contains resource file management and processing logic for class loading, and the view object or the fragment object is loaded and displayed by calling the processing logic.

The page request module 520 is configured to receive a request of starting the host application page containing the plug-in view elements. After the request of starting the host application page containing the plug-in view elements which is triggered by the users is received by the page request module 520, the request unit 531 send a request of acquiring the plug-in view elements to the plug-in framework via the host application. The receiving unit 532 is configured to receive the plug-in view elements acquired by the plug-in framework from the plug-in and the context created by the plug-in.

The displaying module 540 is configured to add and display the plug-in view elements into the host application page, according to the context created by the plug-in. After the context created by the plug-in is acquired, the plug-in view elements call the created context and are added into the host application page. That is, the view object or the fragment object constructed by the plug-in are loaded and displayed into the host application page by calling processing logic included in the context object created by the plug-in.

In the apparatus according to the above embodiments, the context capable of being called by the plug-in view elements is created by the plug-in itself, the plug-in view elements are fed by the plug-in while the context is fed to the host application, so that the host application loads and displays the plug-in view elements into the page using the context. With the apparatus, the plug-in may update silently the plug-in content to update silently interface styles and inherent logic of the host application page.

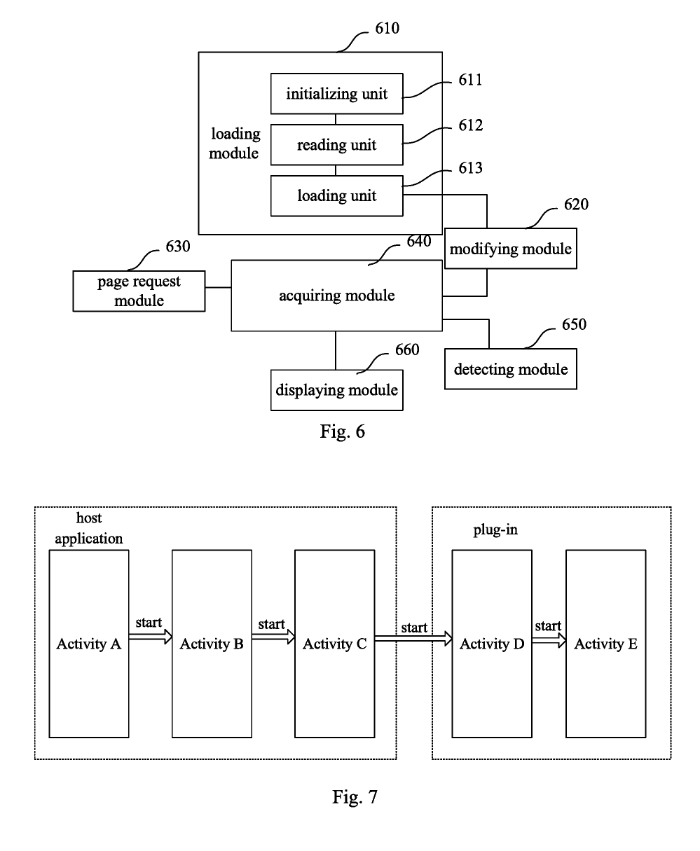

FIG. 6 shows a functional block diagram of an apparatus for displaying plug-in view elements in a host application page according to some embodiments of the disclosure. As shown in FIG. 6, the apparatus includes: a loading module 610, a modifying module 620, a page request module 630, an acquiring module 640, a detecting module 650, and a displaying module 660. The loading module 610 further includes an initializing unit 611, a reading unit 612, and a loading unit 613.

The loading module 610 is configured to load a plug-in when the host application is started. Specifically, the initializing unit 611 is configured to initialize a plug-in framework when the host application is started; the reading unit 612 is configured to read a plug-in file via the plug-in framework; and the loading unit 613 is configured to load the plug-in file into memory of the host application.

The modifying module 620 is configured to modify the context created by the host application.

In the embodiment, the context object capable of being called by the view elements in the plug-in is obtained in a modification way. Specifically, after the plug-in is loaded by the host application, for the context object used by the plug-in view elements, resource file management and processing logic for class loading in the context object created by the host application may be rewritten, so that the context object can be called by the plug-in view elements. The modified or rewritten context object is compatible with processing logic of the plug-in view elements and processing logic of the host view elements.

The acquiring module 640 is specifically configured to acquire the context capable of being called by the plug-in view elements, which is obtained by modifying the context created by the host application.

The page request module 630 is configured to receive a request of starting the host application page containing the plug-in view elements. After the request of starting the host application page containing the plug-in view elements which is triggered by the users is received by the page request module 630, the acquiring module 640 is configured to send a request of acquiring the plug-in view elements to the plug-in framework, and receive the plug-in view elements acquired by the plug-in framework from the plug-in.

The detecting module 650 is configured to detect whether a caller for the context is the plug-in view elements.

The acquiring module 640 is further configured to acquire the context capable of being called by the plug-in view elements, which is obtained by modifying the context created by the host application, if it is detected by the detecting module 650 that the caller for the context is the plug-in view elements.

The displaying module 660 is configured to add and display the plug-in view elements into the host application page, according to the modified context created by the host application. After the modified context created by the host application is acquired, the plug-in view elements call the modified context and are added into the host application page. That is, the view object or the fragment object constructed by the plug-in are loaded and displayed into the host application page by calling processing logic included in the modified context object created by the host application.

In the apparatus according to the above embodiments, the host application modifies the context created by own such that the modified context is compatible with the processing logic of the plug-in view elements. After the plug-in view elements are fed by the plug-in, the host application loads and displays the plug-in view elements into the page using the modified context. With the apparatus, the plug-in may update silently the plug-in content to update silently interface styles and inherent logic of the host application page.

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not shown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and drawings) and any method or all process of the device or unit disclosed as such. Unless there is otherwise explicit statement, every feature disclosed by the display description (including the attached claims, abstract and Figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the devices for displaying the website authentication information according to the embodiments in the disclosure in practice. The disclosure can also realize one part of or all devices or programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

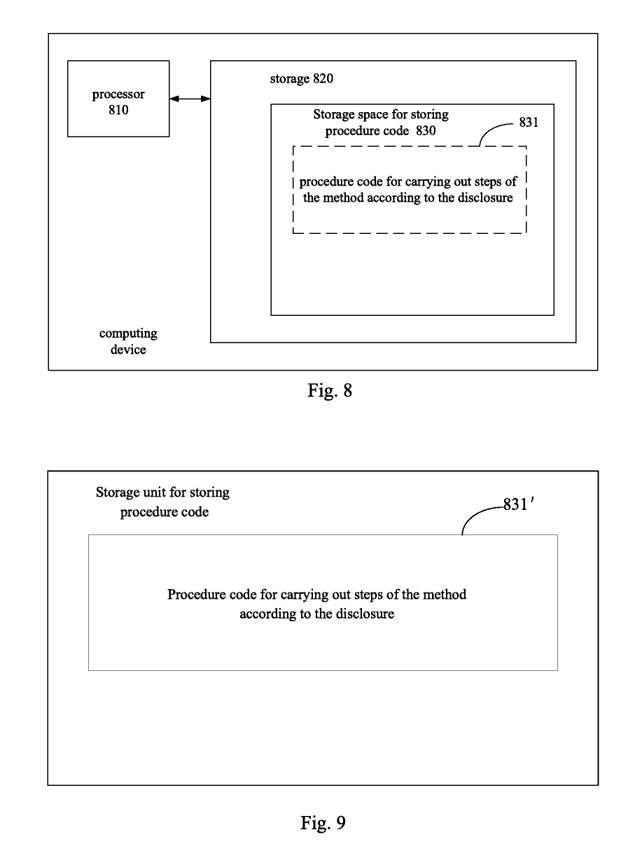

For example, FIG. 8 shows a diagram for a computing device for executing the method for displaying website authentication information according to the disclosure. The computing device traditionally comprises a processor 810 and a computer program product in the form of storage 820 or a computer readable medium. The storage 820 can be electronic storage such as flash memory, EEPROM (Electrically Erasable Programmable Read-Only Memory), EPROM, hard disk or ROM, and the like. Storage 820 possesses storage space 830 for storing procedure code 831 for carrying out any steps of aforesaid method. For example, storage space 830 for storing procedure code can comprise various procedure codes 831 used for realizing any steps of aforesaid method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as shown in FIG. 9. The storage cell can possess memory paragraph, storage space like the storage 820 in the computing device in FIG. 8. The procedure code can be compressed in, for example, a proper form. Generally, storage cell comprises computer readable code 831′, i.e. the code can be read by processors such as 810 and the like. When the codes run on a computer device, the computer device can carry out various steps of the method described above.

The “an embodiment”, “embodiments” or “one or more embodiments” referred here mean being included in at least one embodiment in the disclosure combining specific features, structures or characteristics described in the embodiments. In addition, please note that the phrase “in an embodiment” not necessarily mean a same embodiment.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the devices can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

1.-20. (canceled)

21. A method for displaying plug-in view elements in a host application page, comprising:
loading a plug-in when the host application is started;
acquiring plug-in view elements constructed by the plug-in and a context capable of being called by the plug-in view elements; and
adding the plug-in view elements into a host application page and displaying the plug-in view elements, according to the context.

22. The method according to claim 21, wherein the context includes resource file management and a processing logic for class loading.

23. The method according to claim 21, wherein the acquiring a context capable of being called by the plug-in view elements comprises: acquiring the context created by the plug-in.

24. The method according to claim 23, wherein the loading a plug-in when the host application is started further comprises:
initializing a plug-in framework when the host application is started;
reading a plug-in file via the plug-in framework; and
loading the plug-in file into a memory of the host application.

25. The method according to claim 24, wherein the acquiring the plug-in view elements constructed by the plug-in and a context capable of being called by the plug-in view elements further comprises:
sending, by the host application, a request for acquiring the plug-in view elements to the plug-in framework; and
feeding back, by the plug-in framework, the plug-in view elements acquired from the plug-in and the context created by the plug-in to the host application.

26. The method according to claim 21, wherein the acquiring a context capable of being called by the plug-in view elements comprises: acquiring the context capable of being called by the plug-in view elements, by modifying a context created by the host application.

27. The method according to claim 26, wherein the loading a plug-in when the host application is started further comprises:
initializing a plug-in framework when the host application is started;
reading a plug-in file via the plug-in framework;
loading the plug-in file into a memory of the host application; and
after loading the plug-in file, the method further comprising: modifying the context created by the host application.

28. The method according to claim 27, wherein before the acquiring a context capable of being called by the plug-in view elements, the method further comprises:
detecting whether a caller of the context is the plug-in view elements; and
acquiring the context capable of being called by the plug-in view elements obtained by modifying the context created by the host application, if the context is detected to be called by the plug-in view elements.

29. The method according to claim 21, wherein before the acquiring the plug-in view elements constructed by the plug-in and a context capable of being called by the plug-in view elements, the method further comprises: receiving a request for starting the host application page including the plug-in view elements.

30. The method according to claim 21, wherein the plug-in view elements includes one or more view base units, and/or a view unit capable of being added independently into the host application page and composed of one or more view base units.

31. An electronic device, comprising:
at least one processor; and
a memory communicably connected with the at least one processor for storing instructions executable by the at least one processor, wherein execution of the instructions by the at least one processor causes the at least one processor to:
load a plug-in when the host application is started;
acquire the plug-in view elements constructed by the plug-in and a context capable of being called by the plug-in view elements; and
add the plug-in view elements into the host application page and display the plug-in view elements, according to the context.

32. The electronic device according to claim 31, wherein the context comprises resource file management and processing logic for class loading.

33. The electronic device according to claim 31, wherein the step to acquire a context capable of being called by the plug-in view elements comprises acquiring the context created by the plug-in.

34. The electronic device according to claim 33, wherein the step to load a plug-in when the host application is started comprises:
initializing a plug-in framework when the host application is started;
reading a plug-in file via the plug-in framework; and
loading the plug-in file into memory of the host application.

35. The electronic device according to claim 34, wherein the step to acquire the plug-in view elements constructed by the plug-in and a context capable of being called by the plug-in view elements comprises:
sending a request of acquiring the plug-in view elements to the plug-in framework via the host application; and
receiving the plug-in view elements acquired by the plug-in framework from the plug-in and the context created by the plug-in.

36. The electronic device according to claim 31, wherein the step to acquire a context capable of being called by the plug-in view elements comprises acquiring the context capable of being called by the plug-in view elements, which is obtained by modifying a context created by the host application.

37. The electronic device according to claim 36, wherein the step to load the plug-in file into memory of the host application comprises:
initializing a plug-in framework when the host application is started;
reading a plug-in file via the plug-in framework; and
loading the plug-in file into memory of the host application; and
after loading the plug-in file, execution of the instructions by the at least one processor further causes the at least one processor to modify the context created by the host application.

38. The electronic device according to any one of claim 37, wherein before the acquiring a context capable of being called by the plug-in view elements, execution of the instructions by the at least one processor further causes the at least one processor to:
detect whether a caller for the context is the plug-in view elements; and
acquire the context capable of being called by the plug-in view elements, which is obtained by modifying the context created by the host application, if it is detected that the caller for the context is the plug-in view elements.

39. The electronic device according to claim 31, wherein execution of the instructions by the at least one processor further causes the at least one processor to: receive a request of starting the host application page containing the plug-in view elements.

40. A non-transitory computer-readable storage medium storing executable instructions that, when executed by an electronic device with a touch-sensitive display, cause the electronic device to:
load a plug-in when the host application is started;
acquire plug-in view elements constructed by the plug-in and a context capable of being called by the plug-in view elements; and
add the plug-in view elements into a host application page and displaying the plug-in view elements, according to the context.
